(19) United States
(12) Patent Application Publication
(10) Pub. No.: US 2012/0222911 A1
(43) Pub. Date: Sep. 6, 2012

(54) METHOD AND APPARATUS FOR USE IN TURNING STEERABLE VEHICLE WHEELS

(75) Inventor: Andrew D. Broughton, Lafayette, IN (US)

(73) Assignee: TRW Automotive U.S. LLC

(21) Appl. No.: 13/405,413

(22) Filed: Feb. 27, 2012

Related U.S. Application Data
(60) Provisional application No. 61/448,686, filed on Mar. 3, 2011.

(51) Int. Cl. B62D 5/09; B62D 5/12

(52) U.S. Cl. 180/432

(57) ABSTRACT

An apparatus (1) is used to turn steerable vehicle wheels (50, 52). The apparatus includes a valve (92, 120) which is operated in response to an output from a steering angle sensor (80). When a piston (2) in a power steering motor (12) has reached an end of stroke position, an output from the steering angle sensor (80) operates the valve (92, 120) to interrupt operation of the power steering motor.

### RELATED APPLICATION

This application claims the benefit of the earlier filing date of Untied States Provisional Application Ser. No. 61/448,686 filed Mar. 3, 2011.

### TECHNICAL FIELD

The present invention relates to a method and apparatus for use in providing power assisted turning of steerable vehicle wheels.

### BACKGROUND OF THE INVENTION

A known apparatus for use in turning steerable vehicle wheels is disclosed in U.S. Pat. No. 5,562,017. This apparatus includes a power steering motor having a housing with a chamber in which a piston is disposed. The piston divides the chamber into left and right variable volume chambers. The known apparatus includes a steering control valve. The steering control valve is operable in response to turning of a steering wheel to direct fluid pressure into one of the two variable volume chambers and to connect the other variable volume chamber in fluid communication with a reservoir or source of low pressure fluid. When the piston reaches an end of working stroke position, a piston mounted relief valve system is actuated to vent a pressurized one of the two variable volume chambers to reservoir. This interrupts movement of the piston and the turning of the steerable vehicle wheels.

When a range of movement of the steerable vehicle wheels is to be adjusted, it is necessary to change the position of the piston at which the relief valve system is actuated to vent a high pressure variable volume chamber in the power steering motor. Special equipment has been provided to check and set the relief valves to correspond to a desired end of stroke position of the piston and an end of steering movement of the steerable vehicle wheels.

### SUMMARY OF THE INVENTION

The present invention relates to an apparatus for use in turning steerable vehicle wheels. The apparatus includes a valve which is operated in response to an output from a steering angle sensor. When a piston in a power steering motor has reached an end of stroke position, an output from the steering angle sensor operates the valve to interrupt operation of the power steering motor.

The valve apparatus may be operated in response to only the output from the steering angle sensor to limit turning movement of steerable vehicle wheels. Alternatively, the valve apparatus may be operated to limit both turning movement of steerable vehicle wheels and fluid pressure in a chamber of the power steering motor.

### BRIEF DESCRIPTION OF THE DRAWINGS

The foregoing and other features of the invention will become more apparent upon a consideration of the following description taken in connection with the accompanying drawings wherein:

FIG. 1 is a schematic illustration depicting the relationship between a power steering motor, steering angle sensor, and a valve apparatus which interrupts movement of a piston in the power steering motor in response to an output signal from the steering angle sensor; and

FIG. 2 is a schematic illustration, generally similar to FIG. 1, illustrating the construction of a second embodiment of the apparatus.

### DESCRIPTION OF THE INVENTION

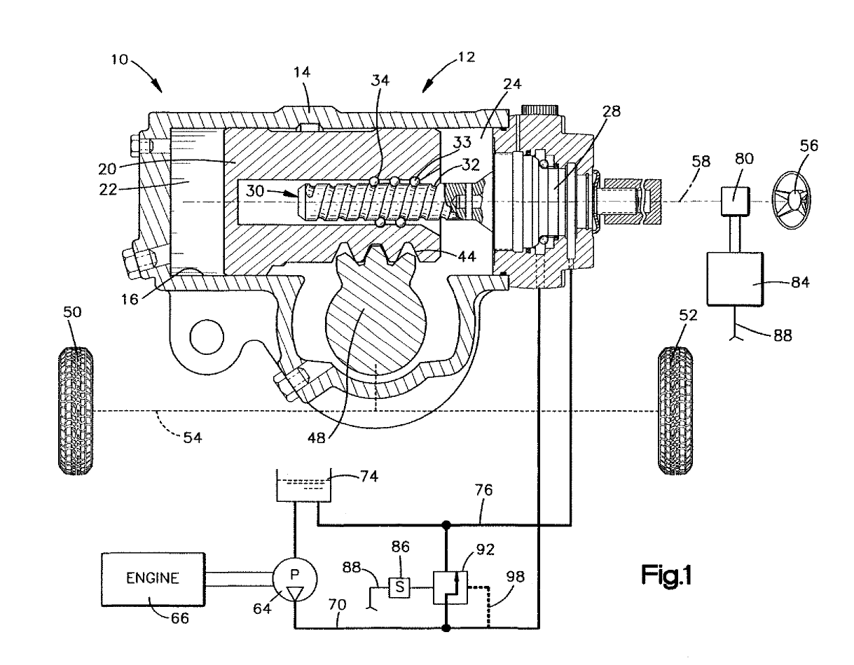

A power steering apparatus 10 constructed in accordance with the present invention is illustrated schematically in FIG. 1. The power steering apparatus 10 includes a power steering motor 12 having a housing 14 in which a motor cylinder chamber 16 is disposed. A generally cylindrical piston 20 is disposed in the housing 14. The piston 20 cooperates with motor cylinder chamber 16 to form left and right variable volume cylinder chambers 22 and 24.

A valve assembly 28 is disposed in the housing 14 and is connected with the piston 20 by a follow-up member 30. The follow-up member 30 has the external thread convolution 32 which cooperates with balls 33 disposed in the internal thread convolution 34 formed in the piston 20.

A series of rack teeth 44 are machined in the piston 20. A pinion gear 48 is disposed in meshing engagement with the series 44 of rack teeth. The illustrated pinion gear 48 is a sector gear. The pinion or sector gear 48 is connected with steerable vehicle wheels 50 and 52 and steering linkage 54. A steering wheel 56 is connected with the valve assembly 28 by a steering column 58.

A power steering pump 64 is driven by an engine 66 of the vehicle. The power steering pump 64 is connected with the valve assembly 28 by a fluid supply or high pressure conduit 70. The valve assembly 28 is connected with a reservoir 74 by a return or low pressure conduit 76.

In accordance with one of the features of the present invention, a steering angle sensor 80 is connected with the steering wheel 56 and valve assembly 28 by the steering column 58. The steering angle sensor 80 has an output which is indicative of the extent to which the steerable vehicle wheels 50 and 52 have been turned from the straight ahead orientation indicated schematically in FIG. 1. Thus, the output from the steering angle sensor 80 is indicative of the position of the steerable vehicle wheels 50 and 52.

The output from the steering angle sensor 80 is conducted to a controller 84. The controller 84 is connected with a solenoid 86 by an electrical conductor 88. The solenoid 86 is energizable by the controller 84 to effect operation of a pressure relief valve 92 from the closed position illustrated schematically in FIG. 1 to an open position.

When the pressure relief valve 92 is in the closed position illustrated in FIG. 1, the pressure relief valve blocks fluid flow between the supply and return conduits 70 and 76. Upon energization of the solenoid 86, the pressure relief valve 92 is actuated to an open condition in which the return conduit 76 is connected with the supply conduit 70 to effect a reduction in the fluid pressure in the supply conduit 70. In addition, the pressure relief valve 92 is operable from a closed position illustrated in FIG. 1 to the open position interconnecting the supply and return conduits 70 and 76 under the influence of fluid pressure conducted from the supply conduit 70 to the pressure relief valve 92 through a conduit 98. If the fluid pressure in the supply conduit 70 should exceed a predetermined pressure, the pressure relief valve 92 is actuated to the open condition under the influence of the fluid pressure conducted through the conduit 98. Thus, the pressure relief valve can be operated from its closed condition to its open condition by the solenoid 86 or by fluid pressure conducted through the conduit 98.

During turning of the steerable vehicle wheels 50 and 52 in response to rotation of the steering wheel 56, the output from the steering angle sensor 80 will vary as a function of the extent of turning movement of the steerable vehicle wheels. As the vehicle wheels are turned in one direction or the other, the piston 20 approaches an end of stroke position. When the piston 20 reaches an end of stroke position, the output from the steering angle sensor 80 indicates that the steerable vehicle wheels 50 and 52 have been turned to a maximum desired extent.

When this occurs, the output from the steering angle sensor 80 is transmitted to the controller 84. The output from the controller 84 through the electrical lead 88 energizes the solenoid 86. Energization of the solenoid 86 operates the pressure relief valve 92 to the open condition. When this occurs, the fluid pressure in the supply conduit 70 decreases and movement of the piston 20 is interrupted.

When the steering wheel 56 is rotated in a first direction, the steering valve assembly 28 directs high pressure fluid to the right variable volume chamber 24 and connects the left variable volume chamber 22 with reservoir through the return conduit 76. The high pressure fluid conducted through the supply conduit 70 to the right variable volume cylinder chamber 24 is effective to move the piston 20 toward the left (as viewed in FIG. 1). When the piston 20 reaches a predetermined end of stroke position, the output from the steering angle sensor 80 is indicative of the fact that steerable wheels 50 and 52 have been turned to the maximum desired extent in one direction. Therefore, the controller 84 effects energization of the solenoid 86 to operate the pressure relief valve 92 to an open condition. When the pressure relief valve 92 is opened, the fluid pressure conducted to the right variable volume cylinder chamber 24 is decreased and movement of the piston 20 is interrupted.

Similarly, if the steerable vehicle wheels 50 and 52 are to be turned in the opposite direction, the steering wheel 56 is rotated to operate the steering valve assembly 28 to direct high pressure fluid to the left variable volume cylinder chamber 22 and to connect the right variable volume cylinder chamber 24 with the reservoir 74 through the low pressure or return conduit 76. This results in the piston 20 being moved toward the right under the influence of fluid pressure in the left variable volume cylinder chamber 22. At this time, the pressure relief valve 92 is in the closed condition illustrated schematically in FIG. 1.

When the piston 20 reaches an end of rightward (as viewed in FIG. 1) working stroke, the output from the steering angle sensor 80 is effective to cause the controller 84 to effect energization of the solenoid 86. Energization of the solenoid 86 operates the pressure relief valve 92 to the open condition in which the supply conduit 74 and return conduit 76 are connected in fluid communication with each other through the pressure relief valve. When this occurs, the fluid pressure in the left variable volume cylinder chamber 22 is decreased and movement of the piston toward the right is interrupted.

The power steering motor 12 and valve assembly 28 have a construction which is generally similar to the construction illustrated in U.S. Pat. No. 3,741,074. Of course, the power steering motor 12 and valve assembly 28 may have a different construction if desired.

The steering angle sensor 80 has a known construction and may be similar to the construction disclosed in U.S. Pat. No. 6,502,025 and/or U.S. Patent Application Publication Nos. 2010/0057299, 2010/0076643, and/or 2010/0235054. If desired, the steering angle sensor 80 maybe connected with the pinion gear 48.

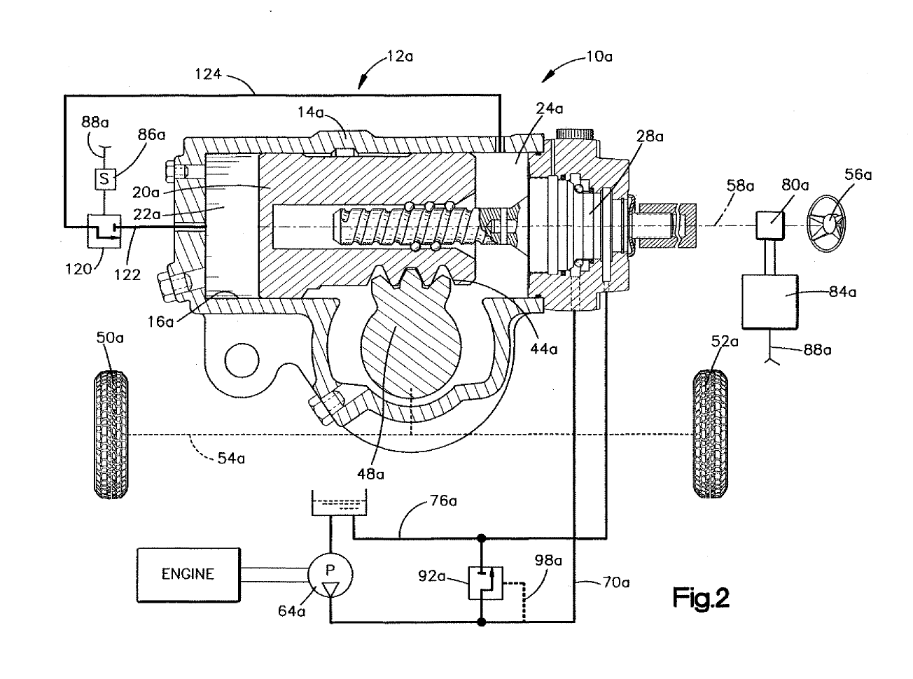

In the embodiment of the invention illustrated in FIG. 1, the pressure relief valve 92 is actuated to interrupt operation of the power steering motor 12 when the piston 20 reaches an end of stroke position. In the embodiment of the invention illustrated in FIG. 2, and end of working stroke valve is actuated independently of the pressure relief valve. Since the embodiment of the invention illustrated in FIG. 2 is generally similar to the embodiment of the invention illustrated in FIG. 1, similar numerals will be utilized to designate similar components, the suffix letter “a” being associated with the numerals of FIG. 2 to avoid confusion.

A power steering apparatus 10a includes a power steering motor 12a having a housing 14a. A motor cylinder chamber 16a is disposed within the housing 14a. A piston 20a is disposed in the housing 14a in the motor cylinder chamber 16a and divides the motor cylinder chamber into left and right variable volume chambers 22a and 24a. A series 44a of rack teeth on the piston 20a are disposed in meshing engagement with a pinion gear 48a. The pinion gear 48a is connected with steerable vehicle wheels 50a and 52a by a steering linkage 54a.

A valve assembly 28a is disposed in the power steering motor 12a and is connected in fluid communication with an engine driven power steering pump 64a by a supply conduit 70a. A return conduit 76a is connected with the power steering valve assembly 28a. A pressure relief valve 92a is operable from the closed condition illustrated schematically in FIG. 2 to an open condition under the influence of fluid pressure conducted through a conduit 98a from the supply conduit 70a.

In accordance with a feature of the embodiment of the invention illustrated in FIG. 2, an end of stroke valve 120 is connected with the left and right variable volume chambers 22a and 24a by conduits 122 and 124. A solenoid 86a is connected with an end of stroke valve 120 is operated by a signal conducted over a lead 88a from a controller 84a. A steering angle sensor 80a is connected with a steering wheel 56a and the valve assembly 20a by a steering column 58a.

When the output from the steering angle sensor 80a indicates that the piston 20a is at an end of working stroke position, the output from the steering angle sensor 80a causes the controller 84a to effect energization of the solenoid 86a. Energization of the solenoid 86a connects the left variable volume cylinder chamber 22a in fluid communication with the right variable volume chamber 24a through the conduits 122 and 124. This results in interruption of the movement of the piston 70a at an end of stroke position.

The steering angle sensor 80a provides an output indicative of the position of the steerable vehicle wheels. The controller 84a effects energization of the solenoid 86a when the output from the steering angle sensor 80a indicates that the steerable vehicle wheels 50a and 52a have been turned through a maximum extent by movement of the piston 20a in the motor cylinder chamber 16a. Therefore, in order to change end of stroke position of the piston 20a it is merely necessary to change the programming of the controller 84a. If desired, the steering angle sensor 80a may be connected with the pinion gear 48a rather than the steering column 58a.

1. An apparatus for use in turning steerable vehicle wheels, said apparatus comprising:
a housing at least partially defining a chamber,
a piston disposed in said housing and dividing said chamber into first and second variable volume chambers, said piston being movable in either one of two piston movement directions toward either one of two end of stroke positions to effect turning movement of the steerable vehicle wheels in either one of two steering directions,
a steering control valve actuated by rotation of a vehicle steering wheel in a first rotational direction to direct fluid pressure into said first variable volume chamber to effect movement of said piston in a first one of the two piston movement directions in said chamber and turning movement of the steerable vehicle wheels in a first one of the two steering directions, said steering control valve being actuated by rotation of the vehicle steering wheel in a second rotational direction to direct fluid pressure into said second variable volume chamber to effect movement of said piston in a second one of the two piston movement directions and turning movement of the steerable vehicle wheels in a second one of the two steering directions,
a steering angle sensor which provides a first output indicative of movement of the said piston in the first one of said two piston movement directions to a first end of stroke position and a second output indicative of movement of said piston in the second one of said two piston movement directions to a second end of stroke position, and
valve apparatus which is operated in response to an output from said steering angle sensor to effect a reduction in fluid pressure in said first variable volume chamber when said steering angle sensor has the first output indicative of movement of said piston to a first end of stroke position and which is operated in response to an output from said steering angle sensor to effect a reduction in the fluid pressure in said second variable volume chamber when said steering angle sensor has the second output indicative of movement of said piston to a second end of stroke position.

2. An apparatus as set forth in claim 1 wherein said valve apparatus is operable to connect said first and second variable volume chambers in fluid communication with each other in response to the fluid pressure in one of said first and second variable volume chambers exceeding a predetermined pressure.

3. An apparatus as set forth in claim 1 wherein said valve apparatus includes a valve assembly which is operable from a closed condition blocking fluid flow through said valve assembly to an open condition enabling fluid to flow through said valve assembly in response to fluid pressure in one of said variable volume chambers exceeding a predetermined pressure.

4. An apparatus as set forth in claim 1 wherein said valve apparatus includes a valve assembly and an actuator which operates said valve assembly from a closed condition blocking fluid flow through said valve assembly to an open condition enabling fluid to flow through said valve assembly in response to said first output from said steering angle sensor and in response to said second output from said steering angle sensor.

5. An apparatus as set forth in claim 1 wherein said valve apparatus includes a valve assembly operable from a closed condition blocking fluid communication between said first and second variable volume chambers and an open condition providing fluid communication between said first and second variable volume chambers in response to said first output from said steering angle sensor and in response to said second output from said steering angle sensor.
